(19) United States
(12) Patent Application Publication
(10) Pub. No.: US 2012/0011463 A1
(43) Pub. Date: Jan. 12, 2012

(54) Method and System for Enabling Location Entry

(75) Inventors: Bruce PAYNE, Kitchener (CA); Ryan James FIORAVANTI, Mississauga (CA)

(73) Assignee: TRAPEZE SOFTWARE INC., Mississauga (CA)

(21) Appl. No.: 13/178,187

(22) Filed: Jul. 7, 2011

Related U.S. Application Data
(60) Provisional application No. 61/364,095, filed on Jul. 14, 2010.

(30) Foreign Application Priority Data
Jul. 7, 2010 (CA) 2,709,116

(51) Int. Cl. G06F 3/048

(52) U.S. Cl. 715/780

(57) ABSTRACT

A method and system for enabling location entry is provided. A text string entered into a free-form location entry field of a user interface is received. At least one location potentially matching the text string is retrieved from a location database managed by a computer system. The at least one location is provided to the user interface for presentation to a user of the user interface.

This application claims priority from Canadian Patent Application No. 2,709,116, filed on Jul. 7, 2010, and from U.S. Provisional Patent Application No. 61/364,095, filed on Jul. 14, 2010, the contents of both which are incorporated herein in their entirety by reference.

### FIELD OF THE INVENTION

The present invention relates generally to information systems. In particular, the invention relates to a method and system for enabling location entry.

### BACKGROUND OF THE INVENTION

Address matching is a process designed to locate a geoposition (typically described via a latitude and longitude coordinate pair) given some user input. This geoposition is then used in GIS applications. For example, a user may want to know how to get from their house to a shopping mall. This is typically done via an itinerary-planning website. The itinerary-planning web site typically uses some kind of address matcher to find the geoposition of their house and the shopping mall. The user might provide the itinerary-planning web site with the street address of their house, and the name of the shopping mall. Often, the user will provide information that is somewhat ambiguous. Perhaps there is a street with the same name as the shopping mall, or maybe three other streets in the particular city that share the same street name as the street the user lives on. Upon completing the input fields of a web page on the itinerary-planning web site, the user submits an itinerary-planning request. The itinerary-planning web site receives the request and the address matcher tries to match the locations in the request and offers the user a list of unambiguous addresses for them to choose from (i.e., “Did you mean . . . ”). Sometimes, the list of address offered back to the user does not even contain the location the user actually wants. It can often take the user two or three attempts to find the location they are interested in.

Google currently provides a type-ahead list of addresses the user has previously searched for. This solution is useful in very limited cases, but is not very helpful where the user has selected to travel to or from a previously-unsearched location.

Some address matchers, such as used by GIRO Inc., provide type-ahead lists on specific data elements. Generally, these systems have a user interface that employs separate input fields for the street number, the street name, the city, etc. Using the street input field, the user can get a list of all the streets in the system.

It is therefore an object of the invention to provide a novel method and system for enabling location entry.

### SUMMARY OF THE INVENTION

In accordance with an aspect of the invention, there is provided a method for enabling location entry, comprising:
receiving a text string entered into a free-form location entry field of a user interface;
retrieving at least one location potentially matching said text string from a location database managed by a computer system; and
providing said at least one location to said user interface for presentation to a user of said user interface.

The text string can be an incomplete location descriptor.

The method can include reiteratively performing the receiving, the retrieving and the providing until one of the at least one location is selected by the user.

The receiving can be triggered by editing of the text string.

The method can include generating the user interface via a web service executing on the computer system. The user interface can be a web page. The free-form location entry field can be dynamically linked to the web service executing on the computer system. The computer system, upon receiving the text string, can match the text string to locations in the location database.

The method can include auto-completing the free-form location entry field upon selection of one of the at least one location by the user.

In accordance with another aspect of the invention, there is provided a method for enabling location entry, comprising:
receiving a text string from a free-form location entry field of a user interface;
matching said text string to at least one location stored in a location database managed by a computer system; and
providing said at least one location to said user interface for presentation to a user of said user interface.

In accordance with a further aspect of the invention, there is provided a computer system for enabling location entry, comprising:
storage storing computer-executable instructions;
a location database stored in said storage for storing locations;
a processor for executing said computer-executable instructions for, in response to receiving a text string from a free-form location entry field of a user interface, matching said text string to at least one of said locations in said location database, and providing said at least one location to said user interface for presentation to a user of said user interface.

The text string can be an incomplete location descriptor.

The processor executing the computer-executable instructions can reiteratively receive the text string, match the text string to at least one of the locations in the location database, and provide the at least one location until one of the at least one location is selected by the user.

The processor executing the computer-executable instructions can receive the text string in response to the text string being edited.

The processor executing said computer-executable instructions can generate said user interface via a web service executing on the computer system. The user interface can be a web page. The free-form location entry field can be dynamically linked to the web service executing on the computer system. The processor executing the computer-executable instructions, upon receiving said text string, can match the text string to locations in the location database.

The user interface can auto-complete the free-form location entry field upon selection of one of the at least one location by the user.

In accordance with a still further aspect of the invention, there is provided a method for enabling location entry, comprising:
generating a user interface via a computer system in response to receiving a request for said user interface, said user interface including a free-form location entry field that is dynamically linked to said computer system, said computer system including a location matching module for receiving a text string entered into said free-form location entry field, and, in response, retrieving at least one location matching said text string in a location database managed by said computer system; and
providing said at least one location to said user interface.

### BRIEF DESCRIPTION OF THE DRAWINGS

Embodiments will now be described, by way of example only, with reference to the attached Figures, wherein:

FIG. 1 shows a high-level architecture of a computer system for enabling location entry in accordance with an embodiment of the invention and its operating environment;

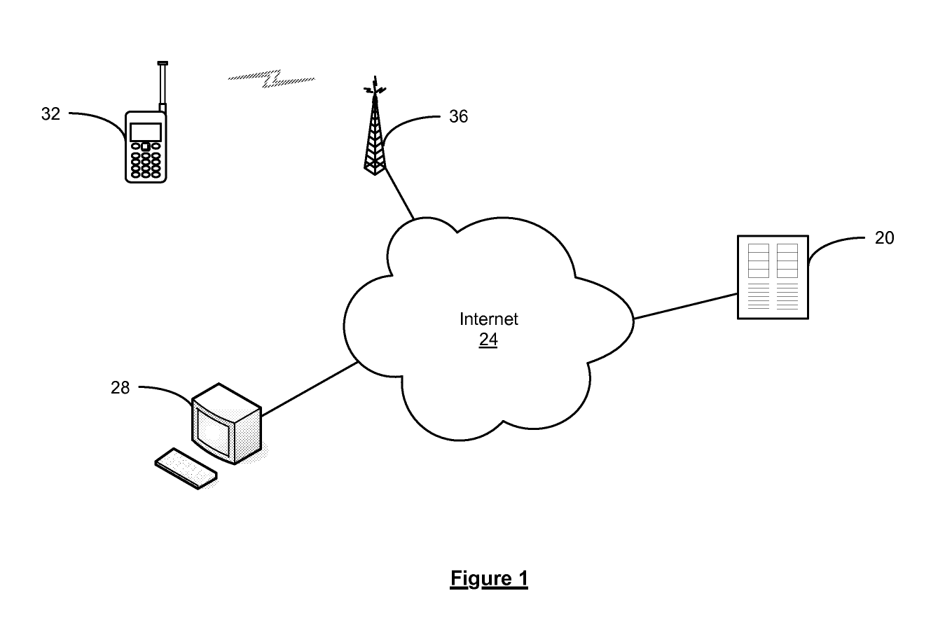

FIG. 2 shows a schematic diagram of the computer system of FIG. 1;

FIG. 3 is a schematic diagram of a number of software components and databases used by the computer system of FIG. 1;

FIG. 4 shows an itinerary-planning interface generated by the computer system and presented on a client device of FIG. 1;

FIG. 5 shows the general method of itinerary-planning used by the computer system of FIG. 1;

FIG. 6 shows the general method of enabling location entry employed by the computer system of FIG. 1;

FIG. 7 shows an option list presented to a user upon typing an incomplete location descriptor into a location entry field;

FIG. 8 shows a different option list presented to a user upon typing an additional character in the location entry field shown in FIG. 7; and

FIG. 9 shows the itinerary-planning user interface of FIG. 5 after the user selects a location from the option list shown in FIG. 8.

### DETAILED DESCRIPTION OF THE EMBODIMENTS

The invention enables a user to be presented with and select from a list of locations potentially matching a text string entered by the user into a free-form location entry field of a user interface that enables location entry. The free-form location entry field permits a user to enter a location in many ways. For example, the free-form location entry field permits a user to identify a location by a street address, an intersection (such as “Queen & Yonge”), a landmark name, a train station name, a route stop number, etc. The list of locations potentially matching the text string entered by the user dynamically changes asynchronously as the user edits the text string in a type-ahead fashion.

By dynamically matching the text string to locations that are known, a user of a user interface that enables location entry can be presented with a list of locations, such as street addresses, street intersections, stop numbers, landmarks, etc., that potentially match the text string. As the user enters more characters of a location descriptor that he has chosen to describe the location he has in mind, the list of potentially-matching locations presented to the user is modified to show locations that best correspond to the text string. In this manner, the user can select a presented location that matches the location he had in mind when he was entering in the text string before they complete entry of the location descriptor. Selection of a location in the presented list auto-completes the free-form location entry field. Further, by dynamically changing the list of locations that potentially match the text string, the user can visually see how their input affects the matching process and can modify the text string directly in response to the list of locations presented before having fully entered the location descriptor. The result is, in many cases, more successful and faster matches.

A computer system 20 for enabling location entry in accordance with an embodiment of the invention is shown in communication with a number of client devices via a large, public network, such as the Internet 24. The computer system 20 is an itinerary-planning system that, in response, to receiving an itinerary-planning request, generates one or more itineraries. A first client device, in particular a personal computer 28, is shown coupled to the Internet 24. A second client device, in particular a smart phone 32, is shown in communication with the Internet 24 via a cellular communications tower 36. The client devices execute a web browser application for interacting with the computer system 20. The cellular communications tower 36 enables mobile devices such as the smart phone 32 to communicate over the Internet 24 via a number of intermediate servers operated by one or more cellular communications carriers (not shown).

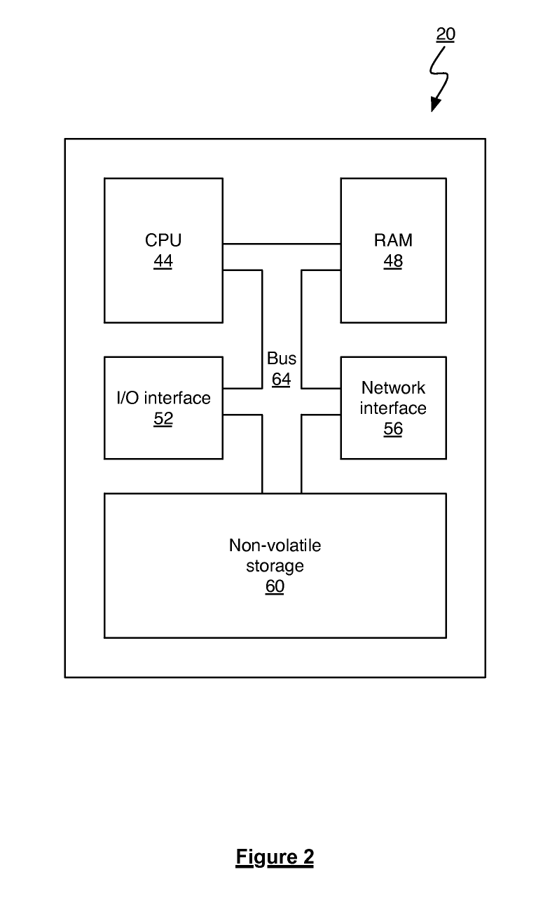

FIG. 2 shows various physical elements of the computer system 20. As shown, the computer system 20 has a number of physical and logical components, including a central processing unit (“CPU”) 44, random access memory (“RAM”) 48, an input/output (“I/O”) interface 52, a network interface 56, non-volatile storage 60, and a local bus 64 enabling the CPU 44 to communicate with the other components. The CPU 44 executes an operating system and a number of other programs and services. RAM 48 provides relatively-responsive volatile storage to the CPU 44. The I/O interface 52 allows for input to be received from one or more devices, such as a keyboard, a mouse, etc., and outputs information to output devices, such as a display and/or speakers. The network interface 56 permits communication with other systems, such as the personal computer 28 and the smart phone 32. Non-volatile storage 60 stores the operating system and programs, including computer-executable instructions for implementing the itinerary-planning software and a database management application for managing databases that are stored in non-volatile storage 60. During operation of the computer system 20, the operating system and the computer-executable instructions may be retrieved from the non-volatile storage 60 and placed in RAM 48 to facilitate execution and access.

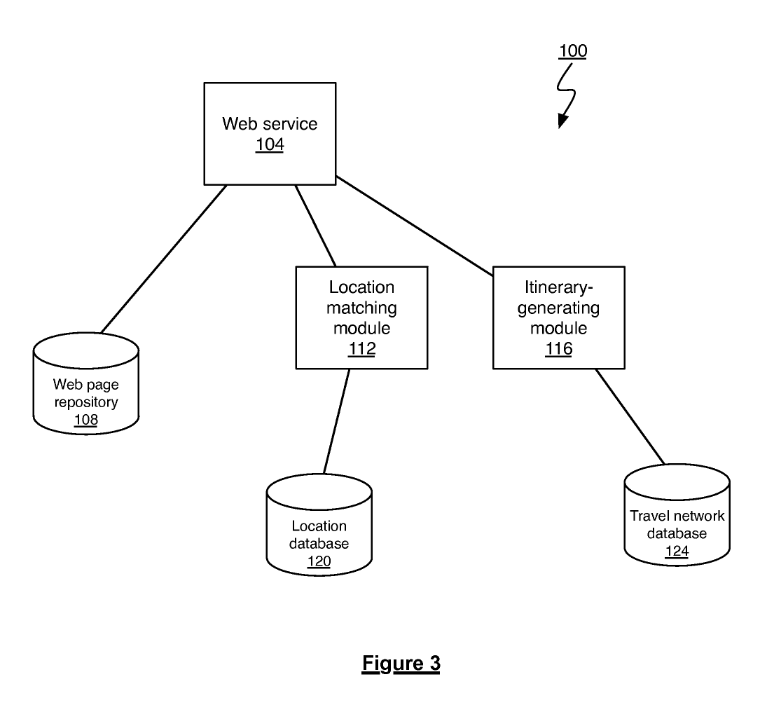

FIG. 3 shows the main software components represented by the computer-executable instructions stored on and executed by the computer system 20, as well as a set of databases used by the software components, and stored in non-volatile storage 60 of the computer system 20. The software components include a web service 104 for enabling client devices such as the personal computer 28 and the smart phone 32 to connect to and receive an itinerary-planning user interface in the form of an itinerary-planning web page. The web service 104 retrieves templates and pages served from a web page repository 108, including the itinerary-planning web page. It is noted that some or all of the page templates and pages stored in the web page database 108 may be cached in RAM 48 during execution. The itinerary-planning web page is dynamically linked to the web service 104 via Asynchronous JavaScript and XML (“AJAX”). This permits the itinerary-planning web page to send data to and receive data from the computer system 20 without having to refresh the entire web page from the computer system 20. The web service 104 orchestrates the various other software components, including a location matching module 112 and an itinerary-generating module 116. When the web service 104 receives data from a client device, such as via a text string entered into a free-form location entry field of the dynamically-linked itinerary-planning web page, it sends a call to the location matching module 112. The location matching module 112 parses the text string and tries to find one or more locations potentially matching the parsed text string in a location database 120. In addition, the location matching module 112 retrieves the geoposition for particular locations from the location database 120. The location database 120 stores locations for a metropolitan area, and corresponding geopositions. For example, the location database 120 stores a table of stop numbers for an urban transit organization and the geoposition for each. In addition, the location database 120 stores a table of landmarks and the geoposition for each. Further, the location database 120 stores a list of all streets for an area. For each street, the location database 120 stores a list of other streets the street intersects and the street address and geopositions for each intersection. The location database 120 also stores geopositions for periodic street addresses between distant adjacent intersections. The locations in the location database 120 are generic, in that they are not specific to a user. The itinerary-generating module 116 attempts to generate one or more itineraries given parameters for a trip, such as the point of departure and the destination, the date of travel and the preferred time of departure or arrival. In order to do this, the itinerary-generating module 116 employs known itinerary-generating techniques and data for various travel networks stored in a travel network database 124. The travel network database 124 stores schedule and route information for fixed-route public transportation networks and information about street and pedestrian networks.

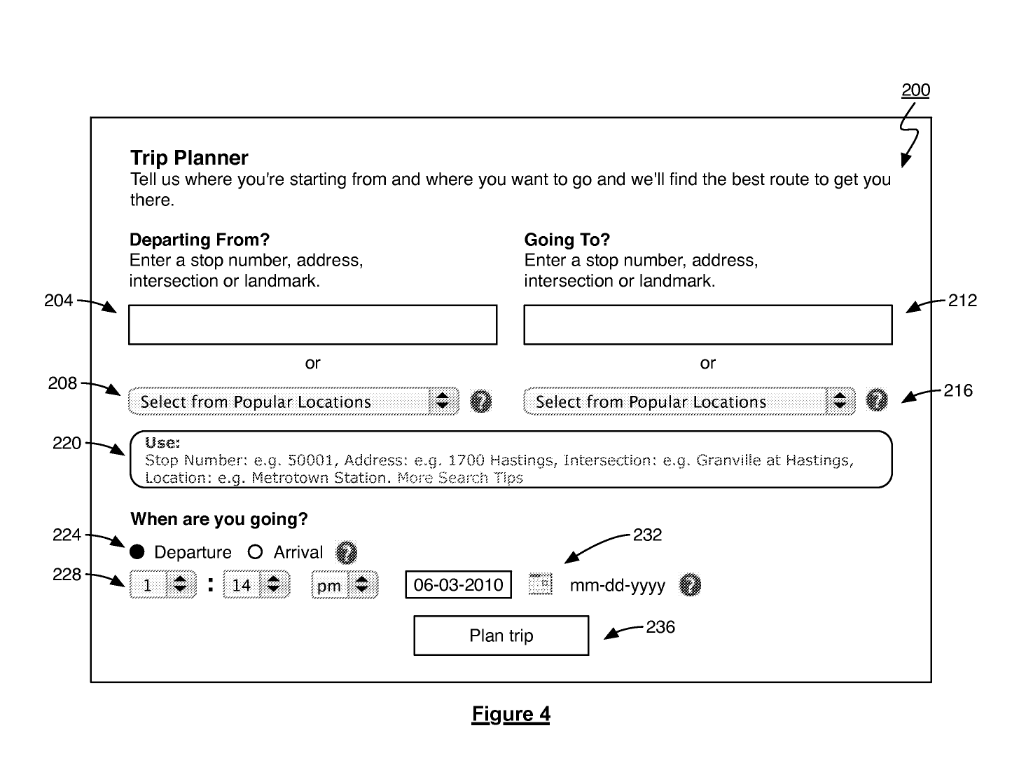

FIG. 4 shows a portion of an itinerary-planning user interface in the form of an itinerary-planning web page 200 generated by the web service of the computer system 20 in response to receiving a client device request for the itinerary-planning web page 200. The itinerary-planning web page 200 enables a user to enter information relating to the trip that he wishes to make, including location information and time information. A departure location entry field 204 is a free-form text field that enables a user to enter a text string that describes a location; that is, the point of departure for the trip. Alternatively, the user can select a departure location from a departure drop-down list 208 of popular locations, such as landmarks, train terminals, etc. Similarly, a destination location entry field 212 is another free-form text field that enables a user to enter a text string that describes a location; in this case, the destination of the trip. The user can alternatively select a destination location from a destination drop-down list 216 of popular locations, such as landmarks, train terminals, etc. Selection of a location via the departure drop-down list 208 auto-completes the departure location entry field 204 with the location. Similarly, selection of a location via the destination drop-down list 216 auto-completes the destination location entry field 212 with the location.

An example field 220 is provided to illustrate some exemplary forms of location descriptors to enable the user to more quickly understand a few of the ways in which a location can be represented in a text string that is entered into the departure location entry field 204 or the destination location entry field 216. As shown, the example field 220 indicates that stop numbers, street addresses, intersections, and locations are all understood by the computer system 20 and provides exemplary entries for each type. For example, the stop number can be entered simply by typing the number itself, and intersections can be identified by typing in the names of the two streets separated by the word “and”.

Departure and arrival radio buttons 224 allow the user to specify if he is entering a desired time of departure or arrival. A set of controls 228 and 232 enable entry of the desired time and date of departure or arrival. A request button 236 enables the user to submit an itinerary-planning request.

As previously noted, the itinerary-planning web page 200 is dynamically linked to the web service 104 via AJAX. Text editing of these fields, such as the entry or modification of a text string, triggers calls to the web service 104 with the text string entered. The calls can return a list of locations potentially matching the text string that may be presented to the user without having to refresh the entire itinerary-planning web page 200 from the computer system 20.

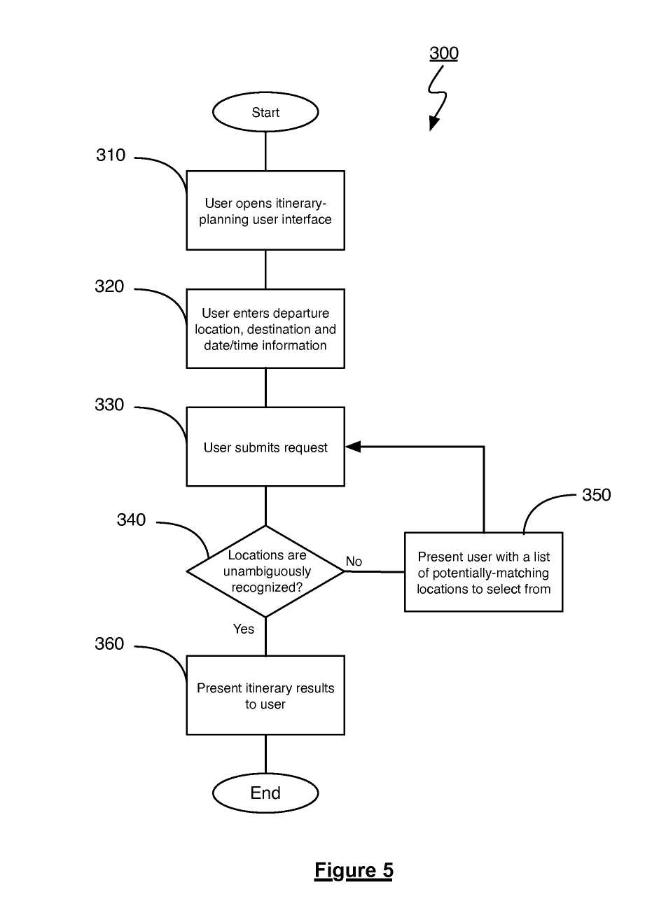

FIG. 5 shows the general method of itinerary-planning via the computer system 20 at 300. The method 300 commences with the user opening the itinerary-planning web page 200 (310). The user can “open” the itinerary-planning user interface by, for example, activating a link to request and open/display the itinerary-planning web page 200. When the itinerary-planning web page 200 is open, the user enters in the departure location, the destination location and the date and time information (320). In particular, to enter the departure location, the user either enters a text string into the departure location entry field 204 or uses the drop-down list 208. Similarly, to enter the destination location, the user either enters a text string into the destination location entry field 212 or uses the drop-down list 216.

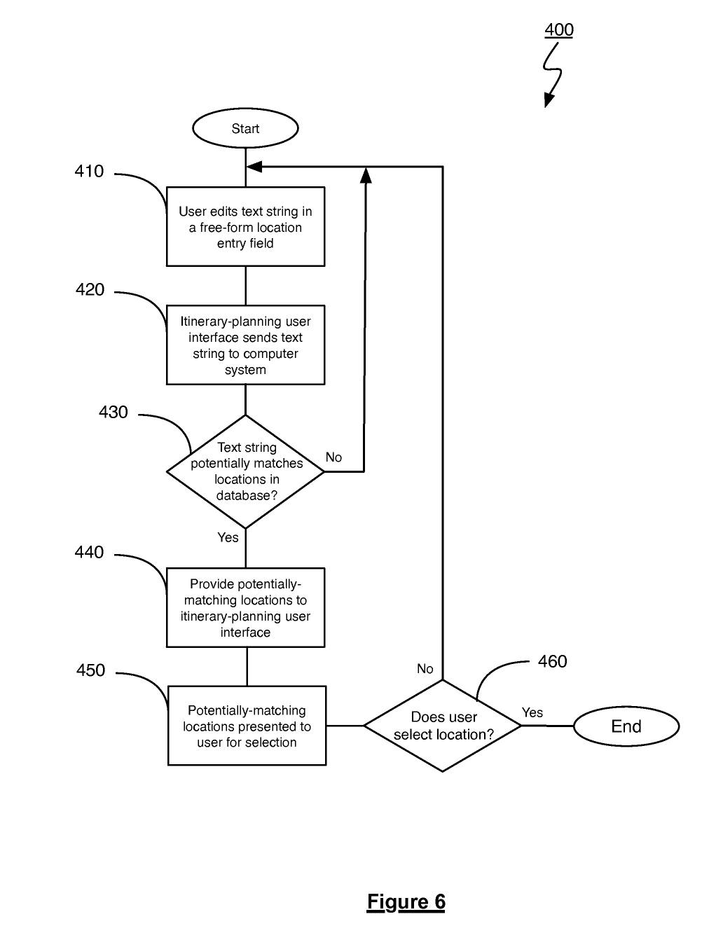

FIG. 6 shows the general method of enabling location entry via the departure location entry field 204 and/or the destination location entry field 212 of FIG. 4 generally at 400. For illustration purposes, location entry via the departure location entry field 204 will be discussed, although it will be understood that the ensuing discussion generally also applies to the destination location entry field 212.

The method commences with the user editing the text string in the departure location entry field 204 (410). Such editing can include the addition of a character, the deletion of one or more characters, the insertion of a string of characters from the clipboard, etc. Typically, such edits are single character additions and deletions through backspacing. Upon receiving the edit, the itinerary-planning web page 200 sends the text string to the computer system 20 (420). The text string is received by the web service 104 and, in turn, the web service 104 calls the location matching module 112 to match the location represented by the text string.

The location matching module 112 checks if the text string potentially matches one or more locations stored in the location database 120 (430). If the text string does not potentially match any of the locations in the location database 120, the location matching module 112 reports that no potentially matching locations were found to the web service 104. The web service 104 then does nothing in response. As a result, the itinerary-planning web page 200 does not display a list of potentially matching locations until the user edits the text string in the departure location entry field 204.

If, instead, the text string potentially matches one or more locations stored in the location database 120, the location matching module 112 provides the list of potentially matching locations to the web service 104, which in turn provides them to the itinerary-planning web page 200 (440). In turn, the itinerary-planning web page 200 presents the list of potentially matching locations to the user for selection (450).

If the user selects one of the locations in the option list 244, the itinerary-planning web page 200 auto-completes the departure location entry field 204 using the selected location (470), after which the method 400 ends. If, instead, the user does not select one of the locations in the option list 244, the itinerary-planning web page 200 awaits further input.

Where the user has elected to enter text into either the departure location entry field 204 or the destination location entry field 212, each edit in the text string in either of the departure and destination location entry fields 204 and 212 causes the itinerary-planning web page 200 to transmit the particular text string to the web service 104.

Returning again to FIG. 5, once all of the required information for an itinerary-planning request is entered into the itinerary-planning web page 200, the user can submit the itinerary-planning request by activating the request button 236 (330). The data from the itinerary-planning web page 200 is posted to the web service 104 as an itinerary-planning request. The web service 104 passes the text strings from the departure location entry field 204 and the destination location entry field 212 to the location matching module 112 for recognition (340).

The location matching module 112 examines the text string provided to determine what areas of the location database 120 to search in. For example, when alphabetic characters are included at the start of the text string, the location matching module 112 may search for landmarks or stop/station names. When the text string commences with numeric values, the location matching module 112 may search for stop numbers that match. If, however, alphabetic characters follow the number(s), the location matching module may search for streets matching the alphabetic characters and assume that the numbers correspond to street numbers. If a separator such as “&”, “and” or “@” is included, the location matching module 112 may try to look up the string portion preceding or following the separator and try to find a matching intersection.

If the location matching module 112 does not match either of the text strings 204, 212 unambiguously to a single location in the location database 120, the location matching module 112 provides a list of locations that potentially match the text string to the web service 104. In turn, the web service 104 transmits a new copy of the itinerary-planning web page 200 that is populated with the data entered previously by the user and includes the list of locations that potentially match the text string entered by the user. For example, the itinerary-planning web page 200 can preface the list of potentially matching locations with the text, “Did you mean . . . ?” The itinerary-planning web page 200 then presents the list of potentially-matching locations to the user for selection (350). That is, if the text string in the departure location entry field 204 was not matched unambiguously to a location in the location database 120, the list of locations potentially matching the text string in the departure location entry field 204 is presented below the departure location entry field 204. Similarly, if the text string in the destination location entry field 212 was not matched unambiguously to a location in the location database 120, the list of locations potentially matching the text string in the destination location entry field 212 is presented below the destination location entry field 212.

Upon selection of a location from the option list, the user can then submit the itinerary-planning request again via the request button 236 at 330. If, instead, the location matching module 112 matches each of the text strings to a location in the location database 120 unambiguously, the location matching module 112 retrieves a geoposition for each location and returns them to the web service 104. The web service 104 then forwards the departure and destination geopositions to the itinerary-generating module 116, together with the time and date information. The itinerary-generating module 116 uses the travel network data stored in the travel network database 124 to generate itinerary results corresponding to the geopositions of the departure and destination locations and the time and date information. The itinerary results can be an empty set if no suitable itineraries are found. Alternatively, the itinerary results can include one or more itineraries that correspond to the itinerary-planning request. The itinerary-generating module 116 transmits the itinerary results to the web service 104. In turn, the web service 104 uses the itinerary results to populate a results web page retrieved from the web page database 108 that is then returned to the client device. The results web page is then presented to the user (360).

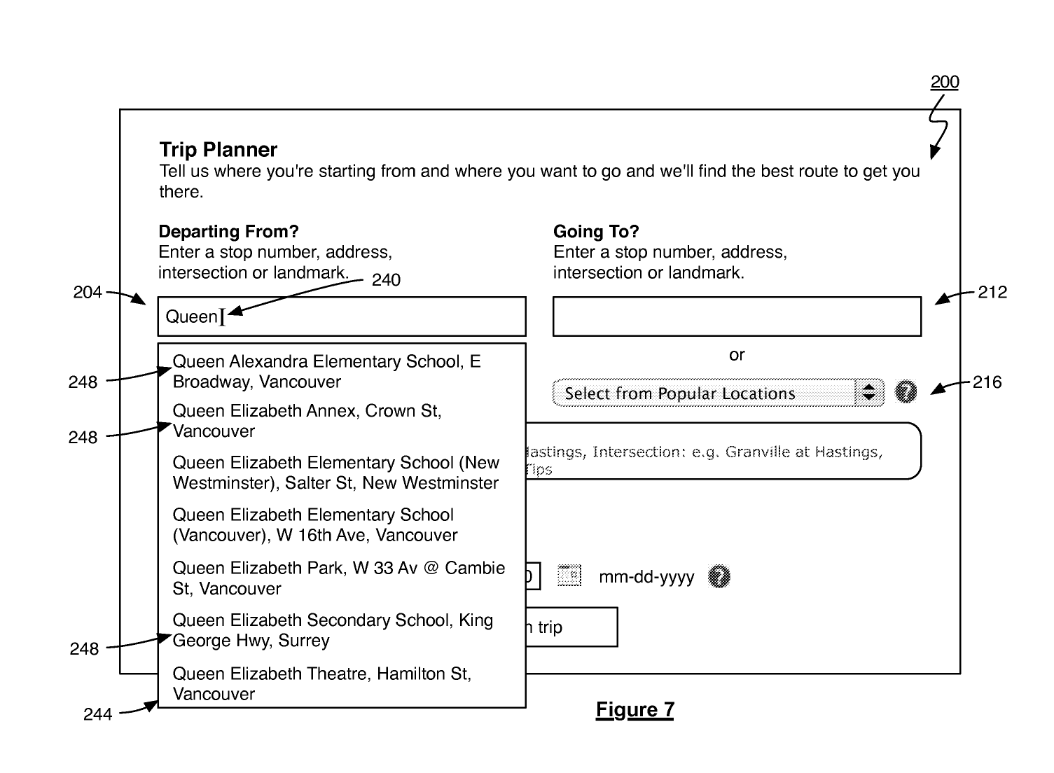

For purposes of illustration, an exemplary scenario will now be described with respect to FIGS. 7 to 9. In the exemplary scenario, a user desires to travel from Queen's Park Arenex, a sports complex, to another location. There are numerous ways to represent this general location, such as via a street address, the complex name, a fixed route public transportation stop number, etc. The user may decide that the location descriptor “Queens Park Arenex” describes the departure location that he wishes to enter. The user opens the itinerary-planning web page 200, selects the departure location entry field 204 and begins to enter the location descriptor, “Queens Park Arenex”.

FIG. 7 illustrates the itinerary-planning web page 200 after the user enters part of the location descriptor; in particular, “Queen”. After entering the incomplete location descriptor, a cursor 240 is located adjacent the end of the text string entered thus far. Upon receipt of the list of potentially-matching locations, the itinerary-planning web page 200 presents the list in an option list 244 that is presented as the user is entering the location descriptor. As shown, the option list 244 includes a number of location options 248 that potentially match the text string, “Queen”. For illustration purposes, the option list 244 shown in FIG. 7 does not include as many location options 248 as would be typically presented to a user upon entry of a text string. Selection of one of the location options 248 would auto-complete the departure location entry field 204. As the location desired by the user does not appear in the option list 244, however, the user continues to enter the location descriptor.

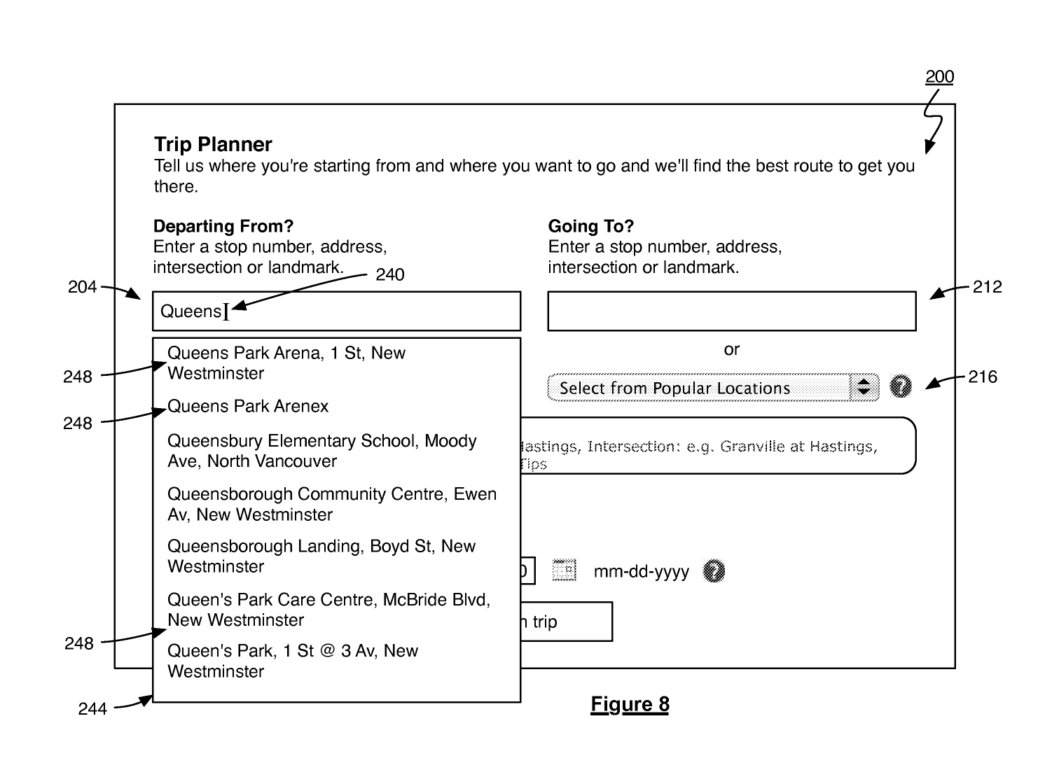

FIG. 8 illustrates the itinerary-planning web page 200 after the user enters an additional character of the location descriptor. In particular, the user has added an “s” to the previously-present text string, resulting in a new text string of “Queens”. Upon receipt of the list of potentially-matching locations, the itinerary-planning web page 200 revises the option list 244 that is presented as the user is entering the location descriptor. As shown, the option list 244 includes a number of location options 248 that potentially match the text string, “Queens”. As will be noted, the location options 248 in the option list 244 differ after appending the “s” to the previously-existing text string, “Queen”. As in FIG. 7, the option list 244 shown in FIG. 8 does not include as many location options 248 as would be typically presented to a user upon entry of a text string. As the location desired by the user (i.e., “Queens Park Arenex”) now appears in the option list 244, the user may select the location option 248.

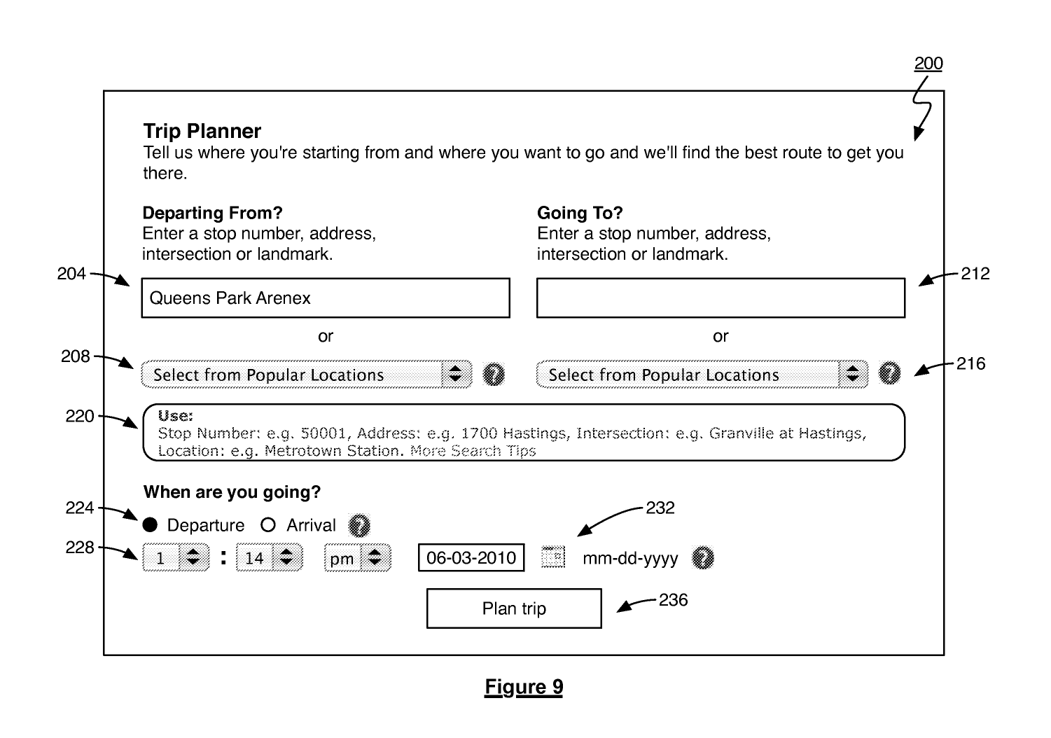

FIG. 9 shows the itinerary-planning web page 200 after selection of the location option matching the desired location. As shown, selection of one of the location options 248 auto-completes the departure location entry field 204.

While the invention has been described with specificity to itinerary planning, other types of implementations will occur to those of skill in the art. For example, a service can employ a user interface that might include a single free-form location entry field that allows a user to enter a location for which proximate restaurants, gas stations, coffee shops, etc. may be desired.

While the computer system is shown as a single physical computer, it will be appreciated that the computer system can include two or more physical computers in communication with each other. Accordingly, while the embodiment shows the various components of the system residing on the same physical computer, those skilled in the art will appreciate that the components can reside on separate physical computers.

In an alternative mode, the user interface can determine if any changes have been made to the text strings in the free-form location entry fields periodically, such as once a second, and then transmit the changed text string(s) to the computer system. This approach can be useful, for example, where it is desired to reduce the amount of data communications between a plurality of user interfaces and the computer system, as communications will be initiated generally at most once a second. In another exemplary similar alternative mode, the user interface can be conditioned to transmit modified text strings in free-form location entry fields periodically, such as once a second, or upon the detection of a pre-defined number of edits (such as character entries) if earlier.

The list of potentially matching locations can be presented to the user via the user interface for a pre-defined period of time, until a particular user event is detected, or indefinitely until the user selects one of the potentially-matching locations or edits the text string in the free-form location entry field.

Where the computer system cannot find any potentially-matching locations for a text string, it can either report a null set back to the interface or can do nothing.

One or more portions of the method may be executed by third parties. For example, a third-party location database may be used.

The above-described embodiments are intended to be examples of the present invention and alterations and modifications may be effected thereto, by those of skill in the art, without departing from the scope of the invention that is defined solely by the claims appended hereto.

What is claimed is:

1. A method for enabling location entry, comprising:
receiving a text string entered into a free-form location entry field of a user interface;
retrieving at least one location potentially matching said text string from a location database managed by a computer system; and
providing said at least one location to said user interface for presentation to a user of said user interface.

2. The method of claim 1, wherein said text string is an incomplete location descriptor.

3. The method of claim 1, further comprising:
reiteratively performing said receiving, said retrieving and said providing until one of said at least one location is selected by said user.

4. The method of claim 1, wherein said receiving is triggered by editing of said text string.

5. The method of claim 1, further comprising:
generating said user interface via a web service executing on said computer system.

6. The method of claim 5, wherein said user interface is a web page.

7. The method of claim 6, wherein said free-form location entry field is dynamically linked to said web service executing on said computer system.

8. The method of claim 7, wherein said computer system, upon receiving said text string, matches said text string to locations in said location database.

9. The method of claim 5, further comprising:
auto-completing said free-form location entry field upon selection of one of said at least one location by said user.

10. A method for enabling location entry, comprising:
receiving a text string from a free-form location entry field of a user interface;
matching said text string to at least one location stored in a location database managed by a computer system; and
providing said at least one location to said user interface for presentation to a user of said user interface.

11. A computer system for enabling location entry, comprising:
storage storing computer-executable instructions;
a location database stored in said storage for storing locations;
a processor for executing said computer-executable instructions for, in response to receiving a text string from a free-form location entry field of a user interface, matching said text string to at least one of said locations in said location database, and providing said at least one location to said user interface for presentation to a user of said user interface.

12. The computer system of claim 11, wherein said text string is an incomplete location descriptor.

13. The computer system of claim 11, wherein said processor executing said computer-executable instructions reiteratively receives said text string, matches said text string to at least one of said locations in said location database, and provides said at least one location until one of said at least one location is selected by said user.

14. The computer system of claim 11, wherein said processor executing said computer-executable instructions receives said text string in response to said text string being edited.

15. The computer system of claim 11, wherein said processor executing said computer-executable instructions generates said user interface via a web service executing on said computer system.

16. The computer system of claim 15, wherein said user interface is a web page.

17. The computer system of claim 16, wherein said free-form location entry field is dynamically linked to said web service executing on said computer system.

18. The computer system of claim 17, wherein said processor executing said computer-executable instructions, upon receiving said text string, matches said text string to locations in said location database.

19. The computer system of claim 15, wherein said user interface auto-completes said free-form location entry field upon selection of one of said at least one location by said user.

20. A method for enabling location entry, comprising:
generating a user interface via a computer system in response to receiving a request for said user interface, said user interface including a free-form location entry field that is dynamically linked to said computer system, said computer system including a location matching module for receiving a text string entered into said free-form location entry field, and, in response, retrieving at least one location matching said text string in a location database managed by said computer system; and
providing said at least one location to said user interface.
